(19) United States
(12) Patent Application Publication
(10) Pub. No.: US 2017/0038231 A1
(43) Pub. Date: Feb. 9, 2017

(54) SENSOR HOUSING WITH INTEGRATED CONTINUOUS ROTATION OF A COVER MEMBER ON A BASE PORTION

(71) Applicant: MTS Sensor Technologie GmbH & Co. KG, Luedenscheid (DE)

(72) Inventors: Christof Ebbing, Hemer (DE); Detlev Guthke, Hagen (DE)

(21) Appl. No.: 15/229,595

(22) Filed: Aug. 5, 2016

Related U.S. Application Data
(60) Provisional application No. 62/201,376, filed on Aug. 5, 2015.

(51) Int. Cl. G01D 11/24; G01D 11/02

(52) U.S. Cl. CPC G01D 11/245; G01D 11/02

(57) ABSTRACT

A sensor housing includes a base portion having an annular recess bounded by a peripheral flange and concentrically oriented with respect to a longitudinal axis. A cover member is secured to the base portion to form an enclosure. The cover member has an annular rim received in the annular recess, while the annular rim has an upwardly facing surface. The cover member is rotatable relative to the base portion with the annular rim at least partially in the annular recess. A coupling mechanism includes one or more fixing elements secured to the peripheral flange. The fixing element directly or indirectly engages the upwardly facing surface to inhibit removal of the annular rim away from the annular recess and fix the rotational position of the cover member relative to the base portion and about the longitudinal axis.

### CROSS-REFERENCE TO RELATED APPLICATION

This application claims the benefit of U.S. Provisional Patent Application Ser. No. 62/201376, filed Aug. 5, 2015, the content of which is hereby incorporated by reference in its entirety.

### BACKGROUND

Sensors commonly comprise a base portion that is fixed joined to a body having a parameter thereof to be measured. For example, the base portion can be secured to a port in a hydraulic circuit or device, where the base forms a fluid tight seal with the body. The sensor further includes a cover member that together with the base portion form a complete enclosure or protective housing for components such as sensor electronics and the like, thereby protecting the components from the outside environment.

Some cover members are secured to their respective base portions in a manner allowing the cover member to be joined in a single known position with respect to the base portion. A disadvantage of such a sensor is that in order to obtain a desired orientation of the cover member when mounted to the body, the base portion must be mounted in a certain position such that the cover member when secured to the base portion achieves the desired orientation. Although there exist other sensors that allow the cover member to be secured to the base portion at a desired orientation after mounting of the base portion, or irrespective of the mounting position of the base portion, the components used to mount the cover member to the base portion can increase complexity of the union formed between the cover member and the base portion, thereby increasing the costs, and/or increasing the overall dimension(s) (e.g. height or width) of the sensor housing.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they in-tended to be used as an aid in determining the scope of the claimed subject matter. The claimed subject matter is not limited to implementations that solve any or all disadvantages noted in the Background.

A sensor housing includes a base portion having an annular recess bounded by a peripheral flange and concentrically oriented with respect to a longitudinal axis. A cover member is secured to the base portion to form an enclosure. The cover member has an annular rim received in the annular recess, while the annular rim has an upwardly facing surface. The cover member is rotatable relative to the base portion with the annular rim at least partially in the annular recess. A coupling mechanism includes one or more fixing elements secured to the peripheral flange. The fixing element directly or indirectly engages the upwardly facing surface to inhibit removal of the annular rim away from the annular recess and fix the rotational position of the cover member relative to the base portion and about the longitudinal axis.

The fixing element can comprise at least one set screw at an angle that is oblique with respect to the longitudinal axis, and preferably a plurality of set screws spaced apart from each other about the longitudinal axis, each set screw at an angle that is oblique with respect to the longitudinal axis.

The coupling mechanism can also comprise one or a plurality of intermediate bearing members engaging the upwardly facing surface, the fixing element engaging the intermediate bearing member(s) on a side remote from the upwardly facing surface. The intermediate bearing member can comprises spherical ball(s) or a ring at least substantially, or completely, encircling and disposed on the annular rim. The fixing element can comprise a fastening ring disposed on the annular rim or one or more spaced apart set screws. Each set screw can be parallel or oblique to the longitudinal axis.

The fixing element can also comprise a spring biased pin engaging the annular rim, while the annular rim includes a plurality of spaced apart recesses about the annular rim, each recess having a lower surface comprising the upwardly facing surface. In a further embodiment, the recesses are disposed in an annular groove.

### BRIEF DESCRIPTION OF THE DRAWINGS

FIG. 1 is a side elevational exploded view of a first embodiment of a coupling mechanism for a sensor housing and a base portion.

FIG. 2 is a partial side elevational view of the first embodiment with a portion broken away.

FIG. 3 is an enlarged sectional view of a portion of FIG. 2.

FIG. 4 is a partial side elevational view of a second embodiment of a coupling mechanism for the sensor housing and the base portion.

FIG. 5 is an enlarged sectional view of a portion of FIG. 4.

FIG. 6 is a partial side elevational view of a third embodiment of a coupling mechanism for the sensor housing and the base portion.

FIG. 7 is an enlarged sectional view of a portion of FIG. 6.

FIG. 8 is a side elevational exploded view of a third embodiment of the coupling mechanism.

FIG. 9 is a side elevational exploded view of a fourth embodiment of a coupling mechanism for the sensor housing and the base portion.

FIG. 10 is a sectional view taken along line 10-10 in FIG. 9. FIG. 11 is an enlarged sectional view of a portion of FIG. 10.

### DETAILED DESCRIPTION OF ILLUSTRATIVE EMBODIMENTS

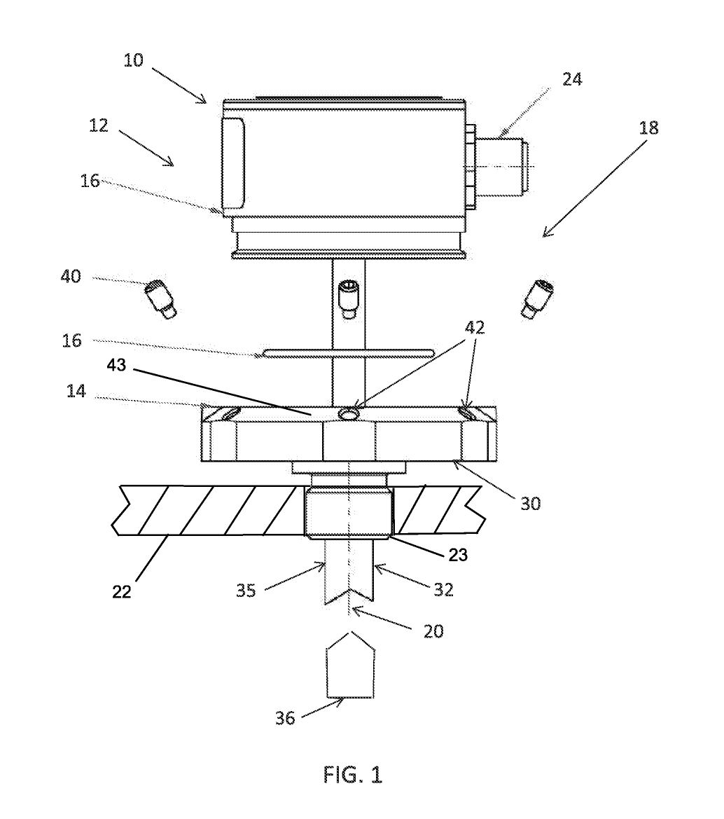

A first embodiment of a sensor 10 is illustrated in FIG. 1. The sensor 10 includes a sensor housing 12 formed by a base portion 14 and a cover member 16. A coupling mechanism 18 formed between the base portion 14 and the cover member 16 joins the cover member 16 to the base portion 14 in a manner that allows the cover member 16 to be disposed in a desired angular position about a center reference axis 20 with respect to the base portion 14 after the base portion 14 has been mounted to a body 22, or irrespective of the mounting position of the base portion 14 to the body 22. The coupling mechanism 18 thus allows the cover member 16 to be oriented to the best position in its environment, for example, so as to allow signal lines, or a connector 24 for the signal lines to be properly positioned when space requirements dictate a certain orientation. The coupling mechanism 18 also allows the cover member 16 to be completely removed from the base portion 14, thereby allowing easy access to components disposed in the sensor housing for servicing or repair.

The rotatable housing can be used for any unit having a base portion 14 that is mounted in a fixed position. In a particular advantageous embodiment, the base portion 14 is mounted to a hydraulic or other fluid circuit or component to form a fluid tight seal with the body 22 using a threaded portion 23. In the embodiment illustrated, the base portion 14 includes a flange 30 and an elongated member or rod 32 that forms an elongated cavity that is isolated from the fluid by a remote end surface 36 and a peripheral wall 35. In one illustrative embodiment, the sensor can be a magnetostrictive sensor having an elongated waveguide disposed in the cavity. A position magnet, not shown, moves axially with respect to the waveguide and the elongated member 32. Inside the sensor a torsional strain pulse is induced in the waveguide by momentary interaction of two magnetic fields. The strain pulse is detected by the electronics in the housing of the sensor. One magnetic field is produced by a moving position magnet, which travels along the elongated member 32 with the waveguide inside. The other magnetic field is generated by a current pulse applied to the waveguide. The position of the moving magnet is determined precisely by measuring the time elapsed between the application of the current pulse and the arrival of the strain pulse at the sensor housing. The result is a reliable position measurement with high accuracy and repeatability.

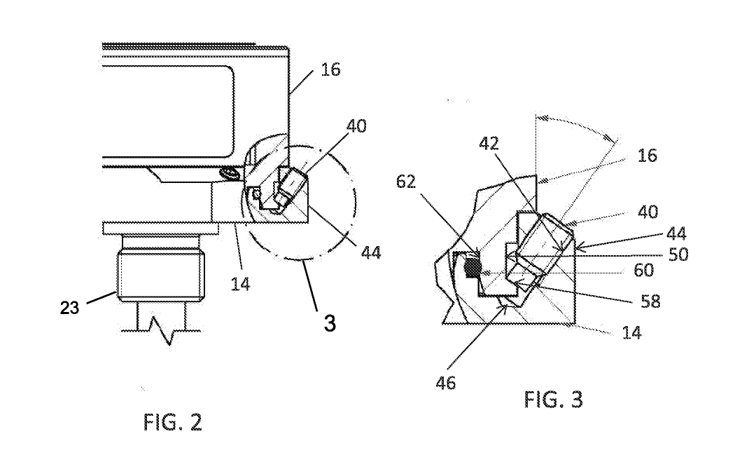

The coupling mechanism 18 between the base portion 14 and the cover member 16 includes at least one and in a further embodiment a plurality of fixing elements 40 mounted in one or more corresponding bores 42 in a peripheral rim or flange 44 in the base portion 14. In the embodiment of FIGS. 1-3, each of the fixing elements 40 comprise pins or set screws having external threads that mate with internal threads of each of the bores 42. The bores 42 are also inclined or oblique (with respect to the axis 20) such that the bores 42 extend inwardly and open to an inner annular recess 46 below an upper surface 43 of the peripheral flange 44. The angle of inclination 41 can be selected as desired. Orienting the bores 42 at an angle of inclination 41 provides convenient use of a tool such as an Allen wrench, hex key, screwdriver or the like to operate the fixing element 40.

The annular recess 46 is configured to receive an annular rim 50 of the cover member 16. Each of the fixing elements 40 are of sufficient length and mating threads of the fixing elements 40 and bores 42 are arranged such that a remote end of each of the fixing elements 40 directly engages the annular rim 50 of the cover member 16 when the annular rim 50 is disposed in the annular recess 46. In the embodiment illustrated, the annular rim 50 includes an upwardly facing annular bearing surface 58 upon which each of the fixing element(s) 40 can bear against. The upwardly facing annular bearing surface 58 can be configured so as to be substantially orthogonal to the inclination of the bore(s) 42. A seal 60 arranged in an annular recess of the base portion 14 engages an inwardly facing surface 62 of the annular rim 50 to seal the internal chamber formed from the base portion 14 and cover member 16. In a preferred embodiment, the annular rim 50 has the same cross-section about the periphery of the cover member 16, which allows the cover member 16 to be secured in any desired rotational position upon the base portion 14 when the fixing element(s) 40 are fixedly secured in the bores 42 and bear against the annular rim 50.

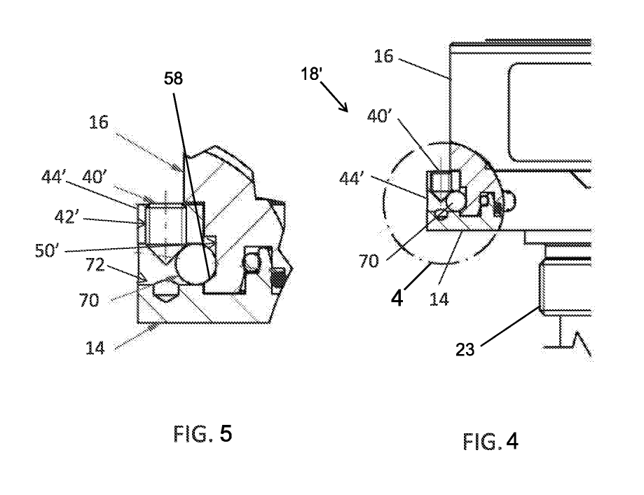

Unlike the direct coupling of the fixing element(s) 40 to the cover member 16 in FIGS. 1-3, the fixing elements 40 of the coupling mechanism 18′ of FIGS. 4 and 5 bear against intermediate bearing member(s) 70 that in turn bear against the annular rim 50′ of the cover member 16. In this embodiment, the threaded bores 42′, which can also be considered apertures, in the peripheral flange 44′ extend parallel to the center reference axis 20 of the sensor 10 rather than being oriented inwardly as in FIGS. 1-3. (However, this should not be considered limiting in that if desired the bores 42′ can be inclined inwardly at an oblique angle as well.)

In the embodiment illustrated, the intermediate bearing member(s) 70 are spherical balls, although other shapes can also be used. Each intermediate bearing member 70 is disposed in a recess 72 below the peripheral flange 44′ that guides the intermediate bearing member 70 allowing only linear movement of the intermediate bearing member 70 herein radial movement toward the annular rim 50′ and against upwardly facing annular bearing surface 58 when the fixing element 40′ bears against the intermediate bearing member 70 on a surface remote such as generally opposite a surface of the intermediate bearing member 70 engaging the annular rim 50′. As with the embodiment of FIGS. 1-3, the configuration of the fixing element(s) 40′, intermediate bearing members(s) 70 and annular rim 50′ allows the cover member 16 to be fixedly secured to the base portion 14 in any desired rotational position.

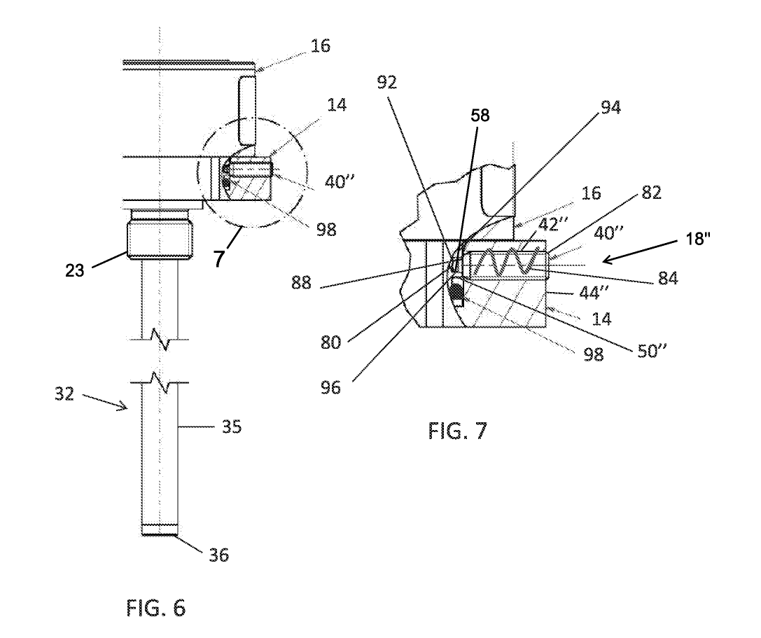

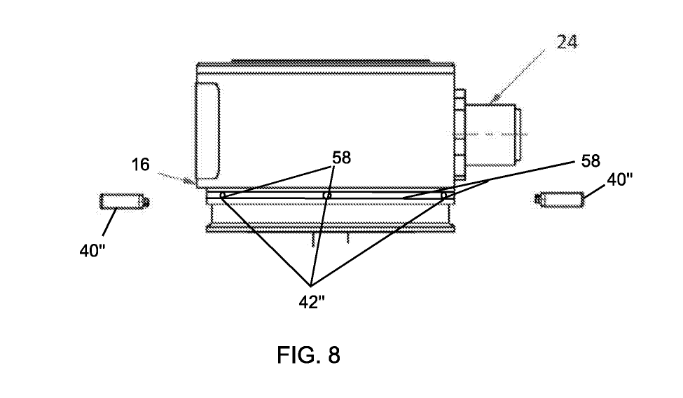

FIGS. 6, 7 and 8 illustrate another coupling mechanism 18″ having one or more fixing elements 40″ to secure the cover member 16 to the base portion 14. In this embodiment, each of the one or more fixing elements 40″ includes a movable pin 80 that is biased outwardly from a support 82 (herein a canister or cartridge) that holds a spring 84 (shown schematically but located within support 82) in compression. The support 82 of the fixing element 40″ is mounted in bores 42″ in the peripheral flange 44″ so that pin 80 is directed inwardly and engages the annular rim 50″ of the cover member 16. In this embodiment, the annular rim 50″ includes spaced apart recesses 88 circumferentially disposed about the annular rim 50″ that face outwardly. When a recess 88 is aligned with a pin 80, the pin 80 projects into the recess 88 and inhibits rotational movement of the cover member 16 on the base portion 14. However, the recess 88 is configured such that upon a sufficient rotational or twisting force exerted upon the cover member 16, the surface of the recess 88 will push the pin 80 into the support 82 against the spring 84 so that the pin 80 is urged out of the recess 88 allowing the cover member 16 to rotate relative to the base portion 14. Upon sufficient rotational displacement that causes another recess 88 to be aligned with the pin 80, the spring 84 will urge the pin 80 into the recess 88, which will again inhibit further rotational movement of the cover member 16 upon the base portion 14. In this manner, the cover member 16 can be rotated to any one of a plurality of selected positions where one or more pins 80 are aligned with corresponding recesses 88.

In a further embodiment, each recess 88 is disposed in an annular groove 92 having upper and lower annular walls 94 and 96. The depth of the groove 92 formed by the walls 94 and 96 is configured such that the pin 80 will not exit the groove 92 even when the pin 80 is not aligned with a recess 88. In this manner, the groove 92 and in particular the lower annular wall 96 inhibits removal of the cover member 16 from the base portion 14 while the cover member 16 is rotated relative to the base portion 14 as well as when the pin 80 has engaged a recess 88. Stated another way, each of the recesses 88 and the groove 92 includes a lower, upwardly facing annular bearing surface 58 (lower surface of recess 88 or annular wall 94) that engages pin(s) 80 so as to inhibit removal of the cover member 16 from the base portion 14. In this embodiment, a seal 98 is disposed between the annular rim 50″ and an inner surface of the peripheral flange 44″.

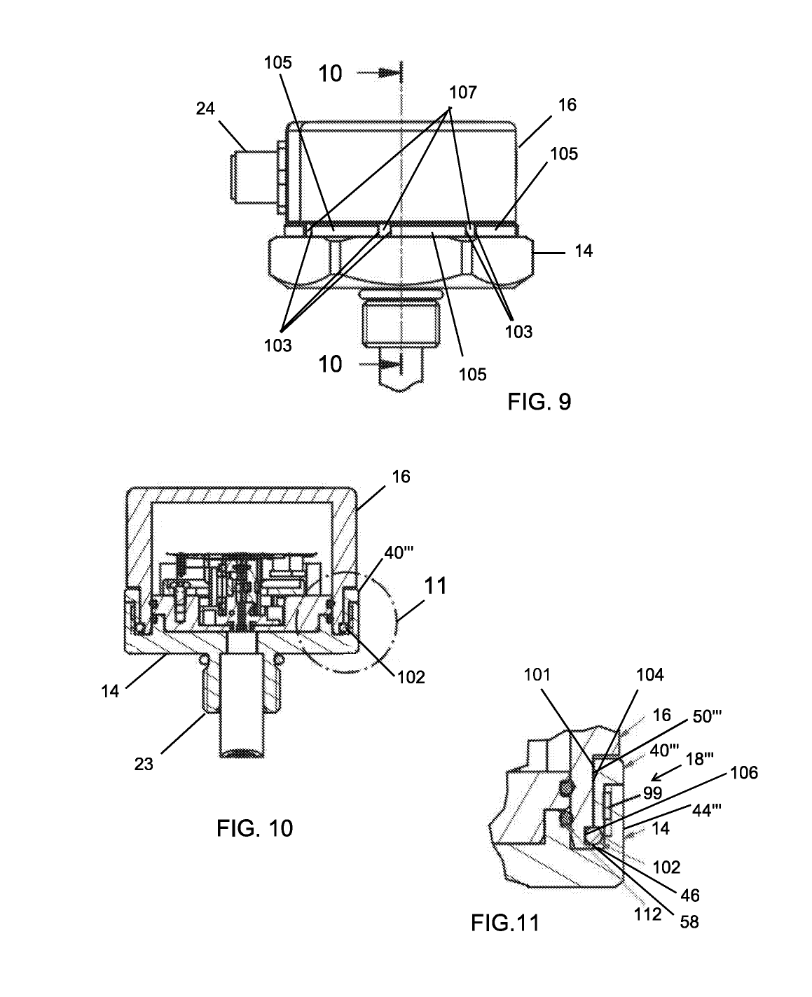

FIGS. 9-11 illustrate yet another form of a coupling mechanism 18′″ to secure cover member 16 to base portion 14. In this embodiment, the coupling mechanism 18′″ includes a fixing element 40′″ in the form of a fastening ring, and an intermediate member 102. The fixing element 40′″ is disposed in an annular recess 46 defining an annular rim 50′″ of the cover member 16 concentrically about an outer surface 104 of the annular rim 50′″, an inner surface 101 of the fixing element 40′″ sliding smoothly upon an outer surface 104. The intermediate member 102 is disposed in a recess 106 of the annular rim 50′″ to inhibit movement of the intermediate member 102 out of the annular recess 46 by gravity when the rim 50′″ is positioned above the annular recess 46 of the base portion 14 formed by peripheral flange 44′″. In one embodiment, the recess 106 comprises an annular groove having an upwardly facing annular bearing surface 58, while the intermediate member 102 comprises a ring substantially if not completely encircling the cover member 16 when disposed in the recess 106.

Upon location of the annular rim 50 partially in annular recess 46 outwardly facing threads of the fixing element 40′″ engage inwardly facing threads as indicated at 99 on the base portion 14 in the desired rotational position of the cover member 16 on the base portion 14. Edges 103 formed on the fixing element 40′″ provided by recesses 105 (or projections 107) formed thereon allow the fixing element 40′″ to be turned such that the threads of the fixing element 40′″ more fully engage the threads of the base portion 14 causing the fixing element 40′″ to bear against the intermediate member 102 driving the cover member 16 toward and against the lower surface of the annular recess 46 to fix the position of the cover member 16 on the base portion 14. Since the inner surface 101 of fixing element 40′″ slides upon the outer surface 104 of the cover member 16, the rotational position of the cover member 16 can remain fixed while the cover member 16 is driven toward the lower surface of the annular recess 46. One or more o-rings 112 seal the enclosed space of the cover member 16 and the base portion 14.

Although the present invention has been described with reference to preferred embodiments, workers skilled in the art will recognize that changes may be made in form and detail without departing from the spirit and scope of the invention.

What is claimed is:

1. A sensor housing comprising:
a base portion having an annular recess bounded by a peripheral flange and concentrically oriented with respect to a longitudinal axis;
a cover member secured to the base portion to form an enclosure, the cover member having an annular rim received in the annular recess, the annular rim having an upwardly facing surface, the cover member rotatable relative to the base portion with the annular rim at least partially in the annular recess; and
a coupling mechanism comprising one or more fixing elements secured to the peripheral flange, the fixing element directly or indirectly engaging the upwardly facing surface to inhibit removal of the annular rim away from the annular recess and fix a rotational position of the cover member relative to the base portion and about the longitudinal axis.

2. The sensor housing of claim 1 wherein the fixing element comprises a set screw at an angle that is oblique with respect to the longitudinal axis.

3. The sensor housing of claim 1 wherein the fixing element comprises a plurality of set screws spaced apart about the longitudinal axis, each set screw being parallel to the longitudinal axis.

4. The sensor housing of claim 1 wherein the fixing element comprises a plurality of set screws spaced apart about the longitudinal axis, each set screw being at an angle that is oblique with respect to the longitudinal axis.

5. The sensor housing of claim 1 wherein the coupling mechanism comprises an intermediate bearing member engaging the upwardly facing surface, the fixing element engaging the intermediate bearing member on a side remote from the upwardly facing surface.

6. The sensor housing of claim 5 wherein the intermediate bearing member comprises a spherical ball.

7. The sensor housing of claim 6 wherein the fixing element comprises a set screw.

8. The sensor housing of claim 5 wherein the intermediate bearing member comprises a ring disposed on the annular rim.

9. The sensor housing of claim 8 wherein the ring is disposed in a groove in the annular rim, the groove having the upwardly facing surface.

10. The sensor housing of claim 9 wherein the fixing element comprises a fastening ring disposed on the annular rim.

11. The sensor housing of claim 10 wherein the fixing element threadably engages the peripheral flange.

12. The sensor housing of claim 1 wherein the fixing element comprise a spring biased pin engaging the annular rim.

13. The sensor housing of claim 12 wherein the annular rim includes a plurality of spaced apart recesses about the annular rim, each recess having a lower surface comprising the upwardly facing surface.

14. The sensor housing of claim 13 wherein the recesses are disposed in an annular groove.
